(19) United States
(12) Patent Application Publication
(10) Pub. No.: US 2015/0120351 A1
(43) Pub. Date: Apr. 30, 2015

(54) SYSTEM AND METHOD FOR EMPLOYEE MANAGEMENT AND WORK ASSIGNMENT

(71) Applicant: Derick Dorner, La Jolla, CA (US)

(72) Inventor: Derick Dorner, La Jolla, CA (US)

(21) Appl. No.: 14/251,099

(22) Filed: Apr. 11, 2014

Related U.S. Application Data
(60) Provisional application No. 61/895,826, filed on Oct. 25, 2013.

(51) Int. Cl. G06Q 10/06

(52) U.S. Cl. CPC G06Q 10/063112; G06Q 10/063118
USPC 705/7.14

(57) ABSTRACT

A software enabled method is provided for matching workers and their skills to employer needs at events. The system using a database of worker skills matches workers in number and skillsets to those identified by an employer as needed for a future job.

This application claims priority to U.S. Provisional Patent Application Ser. No. 61/895,826 filed on Oct. 25, 2013, which is incorporated herein in its entirety by this reference thereto.

### BACKGROUND OF THE INVENTION

1. Field of the Invention

The present invention relates generally to a system for the management of human resources and associated information. More particularly, the disclosed system and method relates to a computer enabled service and method which employs software running on a network accessible computer which provides human resource management in combination with a system for the automated ranking and evaluation and semi-automated scheduling of workers.

2. Prior Art

For a great many businesses the hiring and tracking of workers for performance, time worked, and other information is a major tax on managerial resources. Numerous types of documentation of each worker must be compiled in order to comply with various state and federal worker requirements. For instance most states require copious records on the amount of hours worked by each worker. Further, many states require that each worker be identified as to their work tasks in order to classify them for workman's compensation insurance plans. Equally time consuming for many firms, especially service-oriented businesses, is employee management. In the service industry where the employees of a business are providing a customer with employees to perform tasks, it is important that management assign the appropriate employees and managers to match the requirements of an upcoming customer's event or job.

Currently such human resource tracking and management is generally handled by human resource departments of large businesses, and all too frequently, by the owner or a manager of a small business. Ascertaining and initiating compliance with various state and federal worker requirements, be it initial or ongoing, is a pure overhead cost to most businesses. The cost of employee and management time for simply managing the employees and the compliance by the business with bureaucratic requirements can be a heavy cost burden to businesses, be they large or small.

However, smaller firms are particularly hard hit by such costs since their ability to pass on the costs to customers in the form of burden or overhead mark up is more limited. Larger companies on the other hand have more products and services and sales with which a markup can be included to cover the burden costs of human resource management and government compliance.

With service-oriented businesses, employee management and task-assignment matching to worker strengths is particularly important. The majority of service providing firms in the United States are small local companies since customer's in need of labor or services tend to purchase from local firms. One would hardly hire a New York based service firm to provide a banquet in Los Angeles.

Geographic location of a job or venue to be serviced by workers is a similar concern for service providers. A small firm in a city or county with employees living in specific geographic areas is wise to assign employees capable of providing the labor for a customer's requested task, using employees living closer to the venue for the customer. This is because in many states and localities, employees providing services at venues other than the employer's location must pay the employees from the time they leave home to the time they finish working at the venue. A long commute for a worker can thus equate to increased costs to the business.

Consequently an astute employer will avoid assigning a worker to a job located at a customer's chosen venue which is a long distance away from their home. In addition to the cost of commute time to the employer, both traffic and navigating long distances in a car or public transit can cause a tiring of the employee before they set foot at the assigned venue. Such is hardly beneficial to the employer or the customer.

A major concern to service-providing firms is the proper management and matching the available workers for a job or venue, to the anticipated tasks to be performed by the employees in a job capacity at the venue. Assigning workers lacking a skill or aptitude for anticipated tasks at a customer's venue, will initially increase the employ cost for wages since a worker inexperienced or less skilled at a defined task will take longer to accomplish it. Worse yet, since service-providing firms receive a large portion of their business from customer-referrals, should workers lacking skillsets specific to the anticipated tasks be performed a venue or event, either slow service or poor service or both will inevitably result, which will displease the customer.

A statistic frequently taught in business is that a satisfied customer will generally recommend a vendor if asked by an associate or friend for advice. However a dissatisfied customer will go out of their way to actively disparage a firm who they feel has provided poor customer service or products. Consequently it is imperative for a service providing business to endeavor to assign the best suited workers to perform the anticipated tasks at a customer's event or venue so as to take the surest route in pleasing the customer so as to avoid easily-received bad reviews and to increase good referrals.

An additional concern in staffing events or services provided at a customer venue is the allocation of available management personnel to supervise the assigned workers. Just as the importance of assigning employees adapted to the anticipated tasks is important, the allocation of managers with the proper experience in managing workers for a specific type of event or at a specific venue is also a major concern. A service oriented business should always endeavor to assign enough management staff to a staffed event with the management skillsets for the anticipated job of managing the workers assigned to the same event or venue. Further, employers should endeavor to assign a sufficient number of managing employees, rather than too many so as to ration and use valuable management personnel in a fashion to minimize their cost.

Additionally, many service-related firms, such as caterers and party providers, assign workers to venues based on managements perceived knowledge of individual worker skillsets rather than on the workers actual abilities. This can easily occur when managing personnel are not present along with workers at events serviced by those workers and thus must work with feedback from other workers which may not be especially accurate, especially over a long time duration when skillsets and attitudes of workers can change. Consequently, it is important for most service firms to put some form of worker rating for abilities and attitude which is accurate over time durations and therefor constantly updated by persons actually present at events serviced by the worker being rated.

Still further, while geographic proximity of the worker's home may be criteria employed for such work assignments for events, it is employed less than it should be most likely due to the time involved in mapping of event and cross matching an event locale to travel distances of qualified workers. Further, a forgotten criteria is the fact that workers generally have little or no input into their assigned events and known good workers can tend to be over-assigned while workers with lesser known skillsets can tend to be assigned less frequently than they should. Over a long term such over-assignment of some workers at the expense of others can result in employee burnout and unplanned absences or no-shows of some workers at their assigned events. Allowing employees to a reasonable degree, to schedule themselves based on their actual skillsets, geographic location, and available time for an assignment, would be especially helpful to most businesses since it would free up management time in ascertaining which workers to assign, and would lessen no-shows from employees with conflicting appointments. However, such a system would require a more objective assessment of each worker's respective skill sets, along with some type of proximity criteria, and some worker input to be effective.

As such, there exists an unmet need, for a system employable by small service business concerns to effectively handle worker management. Such a system should be programmed to provide the employer with the ability to properly comply with various state and federal rule and paperwork requirements for employees. This bureaucratic ability should endeavor to track compliance with new-hired workers and the ongoing documentation requirements of federal and state law. Such a system should also provide ongoing work hour tracking of such workers.

Additionally such a system should provide a means for the tracking and assignment of workers and the management personnel in a service oriented business. In this endeavor, such a system should ascertain or provide employer-input for an objective rating system of the skillsets, aptitudes, and learned abilities, for each worker of the employer. Using an ongoing updating system for each worker relative to their respective work and customer skills, such a system should also provide a matching system of workers to upcoming job needs at future events. Still further, such a system should also allow for the employee's geographic proximity to an event, function, or venue for provision of services. Additionally, such a system should track and match management skillsets to upcoming event needs as well as ascertain and provide for a sufficient number of management personnel for each event.

Using this criteria, such a system should provide the workers with a means to input a choice preference to the events and at the venues for which they feel they are most qualified which will inherently allow the employee to ascertain their own ability to handle upcoming workload without burnout. Finally, in doing so, the system should provision or correlate the workers most adapted to known needed skillsets for an upcoming event, and thereby provide a means for management to review the system suggestions and staff their upcoming events using much less management time.

### SUMMARY OF THE INVENTION

The present invention is a computer and software enabled system accessible by a computer network such as the internet. It is enabled by software running on or in communication with a networked computer or server, which is configured to perform to the various tasks of matching the individual staffing requirements of an employer, to various criteria of available respective workers, including which are most qualified by such predetermined criteria, to meet those staffing requirements.

The system employing software enabled with predefined rules and with defined database formats for various worker, event, venue, and other criteria, upon inquiry provides a means for most effectively filling the noted unmet needs of employee management and staffing for employers who are service related firms. Employing a relational database of electronically stored information as to a determined criteria for rating common worker and staffer skillsets, aptitudes, people-skills, work experience, and other factors, the system provides a means for employers to more effectively staff one or a plurality of events or functions, with those workers who are matched to the tasks determined needed at each respective event or function.

The system can further take into consideration criteria such as worker commute distance, worker hours worked, input worker preferences for venues and events, input employer preference for individual workers, and other criteria determined important by the respective employers from experience and industry standards. Employing the system management achieves a much better match of worker to jobsite or function than the current human-memory system employed by most small service firms.

With respect to the above description, before explaining at least one preferred embodiment of the herein disclosed invention in detail, it is to be understood that the invention is not limited in its application to the details of construction and to the arrangement of the steps in the following description or illustrated in the drawings. The invention herein described is capable of other embodiments and of being practiced and carried out in various ways which will become obvious to those skilled in the art on reading this disclosure. Also, it is to be understood that the phraseology and terminology employed herein are for the purpose of description and should not be regarded as limiting.

As such, those skilled in the art will appreciate that the conception upon which this disclosure is based may readily be utilized as a basis for designing of a system for worker and job requirement matching which provides for employee input on preferences for jobs, and the methods and systems for carrying out the several purposes of the present disclosed system. It is important, therefore, that the claims be regarded as including such equivalent construction and methodology insofar as they do not depart from the spirit and scope of the present invention.

It is an object of the invention to provide a web-based system for employer worker management.

It is a further object of this invention to provide such a system which provides for the initial and ongoing needs of worker document processing and ongoing compliance with necessary federal and state documentation.

It is an additional object of this invention to provide such document compliance coupled with appropriate verification of documents such as for social security numbers and employee photos.

Yet an additional object of this invention is initial documentation of employees and projects and a forwarding to a human for completion of subjective or other tasks.

It is a further object of this invention to provide a system enabling employees to self-schedule based on a matching of their skillsets, experience, ranking, and other criteria to upcoming job requirements.

It is yet another object of this invention to automatically manage management personnel and insure that correctly experienced management is combined with ascertained ideal worker and anticipated management requirements at upcoming work to be performed at a job.

It is yet another object of this invention to provide a substantially objective means of ascertaining employee skillsets and amplitudes and matching such to upcoming job requirements and employee self scheduling.

It is yet an additional object of this invention, to solicit for and collect reviews of workers, whereby a profile of each worker may be determined and employed to make decisions about how to manage the worker.

Further objectives of this invention will be brought out and discerned by those skilled in the art through a reading of the following part of the specification wherein detailed description is provided for the purpose of fully disclosing the invention, without placing limitations thereon.

### BRIEF DESCRIPTION OF DRAWING FIGURES

FIG. 1 is a block diagram of a general flow of the disclosed system for matching employees with subjectively rated skillsets to upcoming jobs discerned as requiring such skillsets.

FIG. 2 depicts a more detailed diagram of employer input and matching to reviewed workers.

FIG. 3 depicts a mode of the device where workers or employees interface with the system to input personal data as well as preferences as to potential events or jobsites.

Other aspects of the present invention shall be more readily understood when considered in conjunction with the accompanying drawings, and the following detailed description, neither of which should be considered limiting.

### DETAILED DESCRIPTION OF THE PREFERRED EMBODIMENTS OF THE INVENTION

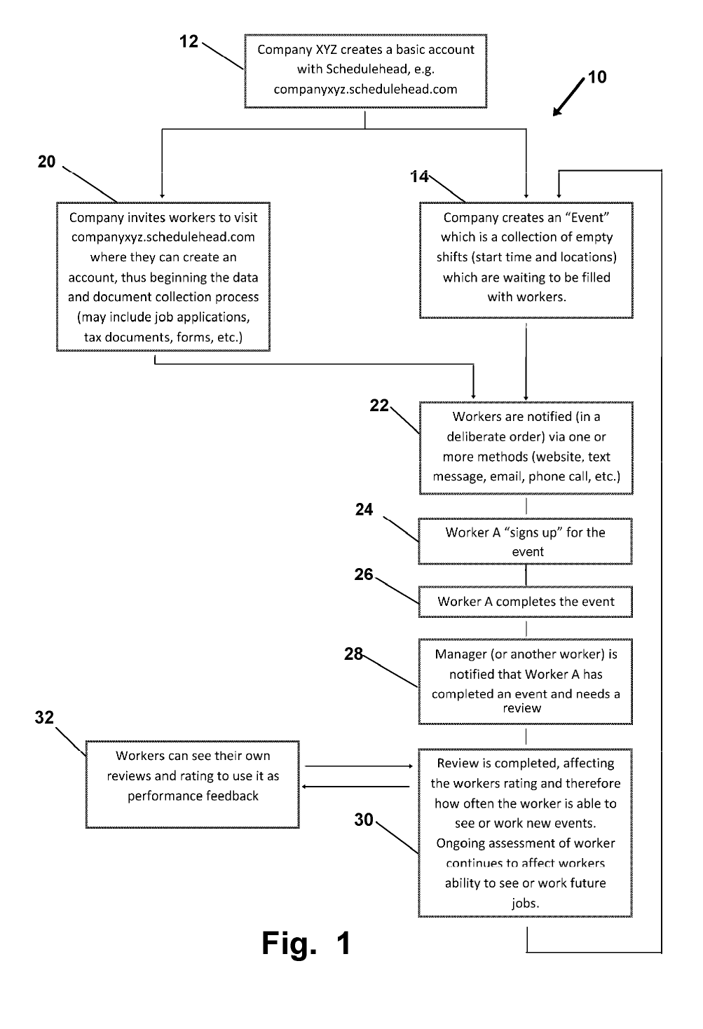

Now referring to drawing, in FIG. 1, there is shown a block diagram, figures representative of the disclosed system 10 herein disclosed. In a first step 12 employers will be provided a remotely displayed text editable screen or screens, to subscribe to the service and input relevant company location and identification information. Once so registered, the subscribing company can also input their government tax identification numbers should they wish the system to handle preparation of forms relevant to such filings pursuant to workers.

Once so registered a company is then given access to the system on an ongoing basis, to input upcoming events 14 where workers will be required. Such input will generally be menu driven and allow the employer to input event criteria 14 such as times, shift lengths, shifts available, and other criteria enabling the matching of workers to the event.

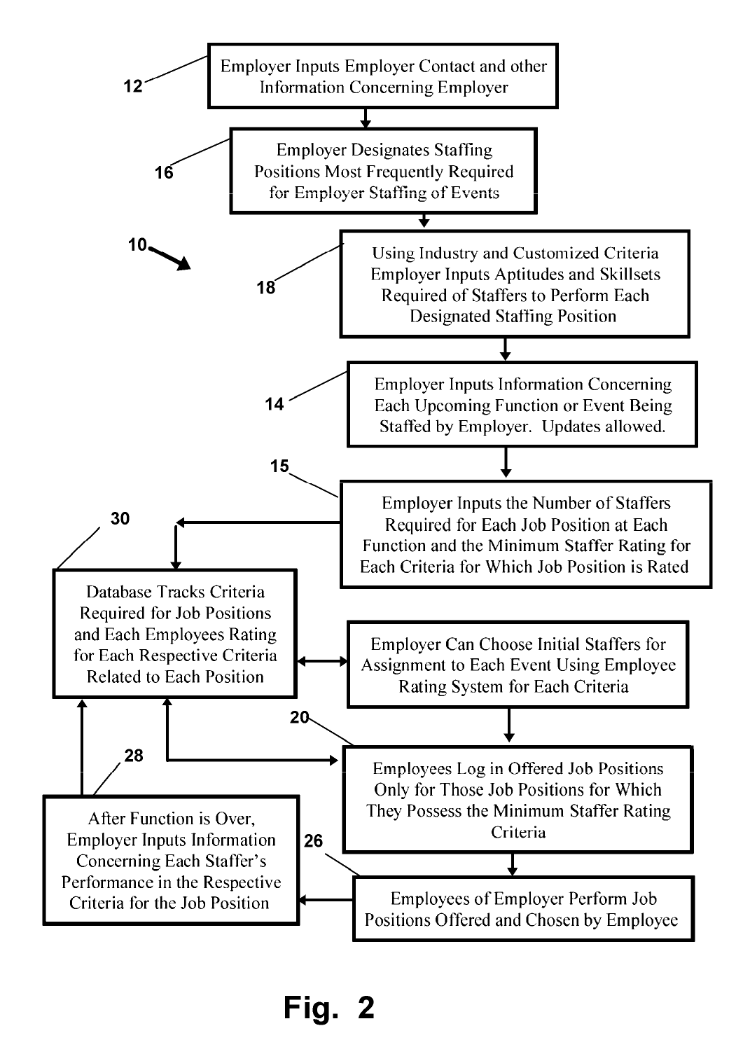

Such input may also include a designation of certain staffing position types most frequently desired 16 (FIG. 2) by the subscribing company at different events. There can be multiple staffing position types, and in another step, the staffing types preferred by the subscribing company are matched to one or a plurality of multiple skillsets 18 FIG. 2, all which are held in a relational database in memory and made relational to the subscribing company. In inputting the event information 14, the employer may also be given screens or input fields for inputting an estimated number of workers for each event 15. Additionally provided may be screens allowing employer input for employee ratings for experience in the skillsets determined by the employer as required for the event.

Once an employer has subscribed 12, the subscribing company can be given the ability to invite workers 20 where they can visit the provider of the system, and input normal employee documentation and information required by government agencies for subsequent employee reporting. Additionally input would be contact information and any criteria for which the subscribing employer wishes rated or answered by workers.

Once an employer is a subscriber and workers have subscribed to the system 10 who are related to a specific subscribing employer, the system will employ software adapted to the task of matching workers to subscribing employer input events. The workers are then notified 22 of an upcoming event via electronic contact such as email, texting, or other means.

Subsequent to notification of being invited to sign up for a future event, workers are allowed to log onto the system and sign up for respective events 24. The system will match the number of workers to the available shifts and types of workers with desired skillsets designated by the subscribing company in the input step of the event. At this juncture the subscribing company may be given opportunity to review the system determined workers and have a final say, or the system will just assign the workers determined a best match for the event based on predetermined subscribing employer and/or industry input standards.

Once an event is completed by a worker, the system will notify and/or request a review of each employees performance from a designated manager or employee who was also present at the event 28. The system will intake the review when completed 30 and adjust the respective workers ratings for the skillsets or qualities the subscribing employer has set in the system for employees. This adjustment in the employee rating can and will affect each worker privileges to be notified of future events, and/or to be assigned to future events by the system. This is because as shown in FIG. 2, the database will relate respective worker strengths and weaknesses to the respective positions required by subscribing employers for the shifts they make available at future events 30 and a higher rating for desired worker traits will yield more or better event offers.

In an effort to better inform workers of their strengths and shortcomings, the system will provide workers with a synopsis or other review of the rating just received 32 which will enable workers to work on any weak areas and know their current strengths to better enable them to increase their rating in the system. Many workers lack such feedback and fail to improve or try due to lack of knowledge of exactly what is wanted from them and this system helps solve that problem and put a bit of competition in the worker ranks for the higher ratings both of which are good for employer and worker in the long run.

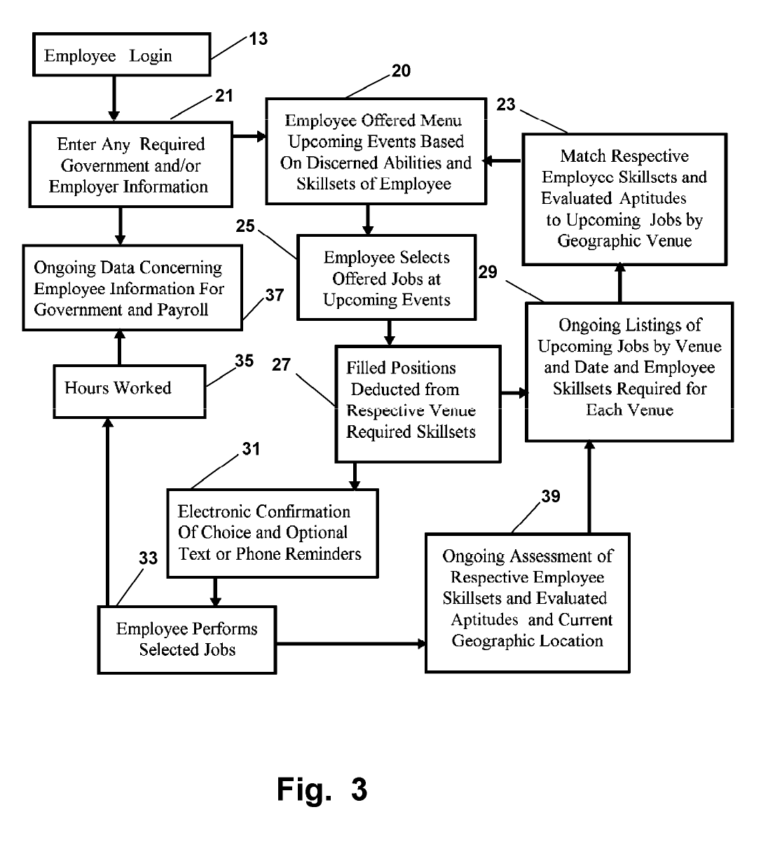

In FIG. 3 is shown a mode of the worker participation in the system 10. It should be noted that while many subscribing companies have full staffs, many do not, or are looking to fill unfilled shifts when lacking workers. The system 10 herein by registering workers and knowing their aptitudes and skill sets, can provide backup to a smaller service provider for larger events since the system 10 can suggest workers matching a subscribing employers criteria, when needed for extra shifts and large events.

As noted, after logging into the system 13, the worker enters required government information 21, and may enter their perceived job abilities and strengths. Thereafter, the workers will be invited 20 to upcoming shifts at upcoming events based on the systems matching 23 of their skillsets and strengths to the subscribing employers requirements for workers for shifts.

So invited to one or a plurality of shifts at events, the worker can select 25 the shifts at events offered. Once the worker selects shifts and events, the filed positions are deducted from those offered subsequent invited workers to view 27 in the ongoing listings 29 of upcoming shifts and events. Generally the workers will be provided with confirmation of chosen shifts and events, via electronic messaging or phone reminders 31.

Once the worker has performed in shifts at events such is input to the system by the employer 33 and the hours worked 35 are communicated to the system in ongoing updating of worker data 37 so payroll and other reports may be prepared for subscribing employers, or data provided them for such.

As noted, there is an ongoing assessment 39 of all workers which is updated on an ongoing basis using input reports from designated persons from each subscribing employer. The designated persons may be contacted electronically and led to an online input screen for such purpose to insure ongoing compilation of improving workers and such. As such, the system 10 herein can provide subscribing companies with exceptional worker tracking and venue and event matching, and scheduling to upcoming events. The system can also allow for workers to be shared or placed in a pool of workers each having worker data 37 and thereby, allow smaller firms to attempt larger events with the knowledge that reputable extra workers, with capabilities and experience matchable to an event, are available from the system 10 to staff such events beyond those specifically related to the subscribing company.

While all of the fundamental characteristics and features of the software enabled employee management and matching system herein have been shown and described herein, with reference to particular embodiments thereof, a latitude of modification, various changes and substitutions are intended in the foregoing disclosure and it will be apparent that in some instances, some features or steps in the invention may be employed without a corresponding use of other features or steps without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. A software enabled method for matching workers to employer events, comprising the steps of:
providing workers access over a network to a server;
communicating to a computing device of said workers, input screens allowing said workers to input worker information into fields to establish a worker profile;
including at least, worker electronic contact information, worker location, and worker skills in said worker profile;
storing each said worker profile to a relational database including a plurality of said worker profiles;
providing employers access over said network to said server;
communicating to a computing device of said employers, input screens allowing said employers to input employer information into fields to establish an employer profile;
subsequent to establishing said employer profile, communicating a displayable graphic interface for said employers to communicate to said server, event information including an event venue, an event date, and an employer-estimate of a required number of workers to service said event, and
communicating a displayable graphic interface to said employer providing fields for said employer to input respective desired said worker skills for each of said required number of workers;
employing software configured to ascertain a respective match of respective said worker profiles having said worker skills to said desired said worker skills communicated by said employer;
providing said workers subsequent to establishment of their respective worker profile, a graphic interface for initiating job inquiries;
providing respective said workers initiating a said job inquiry with a listing of said event information, for respective said events communicated by a said employer, which result in a respective match to said worker; and
allowing said workers to choose one or a plurality of said events in said listing as their respective jobs for performance of work.

2. The software enabled method for matching workers to employer events of claim 1, additionally including:
subsequent to said performance of work by respective said workers, providing a graphic interface to said employers to input a ranking of one or a plurality of said skills of said respective worker on a said event chosen by said worker as their respective job;
employing said ranking input by said employer to adjust a score for said one or a plurality of skills of said respective worker to achieve an adjusted skill ranking; and
employing said adjusted skill ranking in ascertaining said respective match between said skills of said respective worker.

3. The software enabled method for matching workers to employer events of claim 1, additionally including:
only ascertaining a said match of said skills of a respective said worker solely to respective said desired worker skills communicated by a single said employer.

4. The software enabled method for matching workers to employer events of claim 2, additionally including:
only ascertaining a said match of said skills of a respective said worker solely to respective said desired worker skills communicated by a single said employer.

5. The software enabled method for matching workers to employer events of claim 1, additionally including:
employing said respective match of respective said worker profiles having said worker skills to said desired said worker skills communicated by a said employer to ascertain respective employees suitable for said job; and
employing said electronic contact information related to said respective workers discerned in said match, to contact said respective workers and elicit said job inquiries.

6. The software enabled method for matching workers to employer events of claim 2, additionally including:
employing said respective match of respective said worker profiles having said worker skills to said desired said worker skills communicated by a said employer to ascertain respective employees suitable for said job; and
employing said electronic contact information related to said respective workers discerned in said match, to contact said respective workers and elicit said job inquiries.

7. The software enabled method for matching workers to employer events of claim 3, additionally including:
employing said respective match of respective said worker profiles having said worker skills to said desired said worker skills communicated by a said employer to ascertain respective employees suitable for said job; and
employing said electronic contact information related to said respective workers discerned in said match, to contact said respective workers and elicit said job inquiries.

8. The software enabled method for matching workers to employer events of claim 4, additionally including:
employing said respective match of respective said worker profiles having said worker skills to said desired said worker skills communicated by a said employer to ascertain respective employees suitable for said job; and
employing said electronic contact information related to said respective workers discerned in said match, to contact said respective workers and elicit said job inquiries.

9. The software enabled method for matching workers to employer events of claim 2, additionally including:
allowing said workers to view respective said rankings of one or a plurality of their said skills at a past said event chosen by said worker as their respective job as a means for educating said worker as to said skills needing improvement.

10. The software enabled method for matching workers to employer events of claim 6, additionally including:
allowing said workers to view respective said rankings of one or a plurality of their said skills at a past said event chosen by said worker as their respective job as a means for educating said worker as to said skills needing improvement.
